(19) United States
(12) Patent Application Publication
(10) Pub. No.: US 2015/0061550 A1
(43) Pub. Date: Mar. 5, 2015

(54) Method for electrically regenerating an energy store

(71) Applicants: Udo SCHULZ, Vaihingen/Enz (DE); Jochen Pflueger, Simmozheim (DE); Stefan Andreas Kniep, Hildesheim (DE)

(72) Inventors: Udo SCHULZ, Vaihingen/Enz (DE); Jochen Pflueger, Simmozheim (DE); Stefan Andreas Kniep, Hildesheim (DE)

(73) Assignee: Robert Bosch GmbH, Stuttgart (DE)

(21) Appl. No.: 14/469,797

(22) Filed: Aug. 27, 2014

(30) Foreign Application Priority Data
Aug. 30, 2013 (DE) 10 2013 217 346.6
Sep. 6, 2013 (DE) 10 2013 217 897.2

(51) Int. Cl. H02P 3/14

(52) U.S. Cl. CPC H02P 3/14
USPC 318/376

(57) ABSTRACT

A method for electrically regenerating an electrical energy store in a motor vehicle which includes a recuperation device and/or other energy-saving devices, including the following: based on information concerning an upcoming travel route, it is ascertained whether a suitable opportunity exists for an electrical regeneration on the upcoming travel route, and when this is the case: a first energy loss is determined which occurs during the electrical regeneration; a second energy loss is determined which results on a plurality of previously determined and defined routes due to aging effects of the energy store which are reversible with the aid of regeneration; the first energy loss and the second energy loss are compared, and a regeneration is carried out only when the second energy loss is greater than the first energy loss.

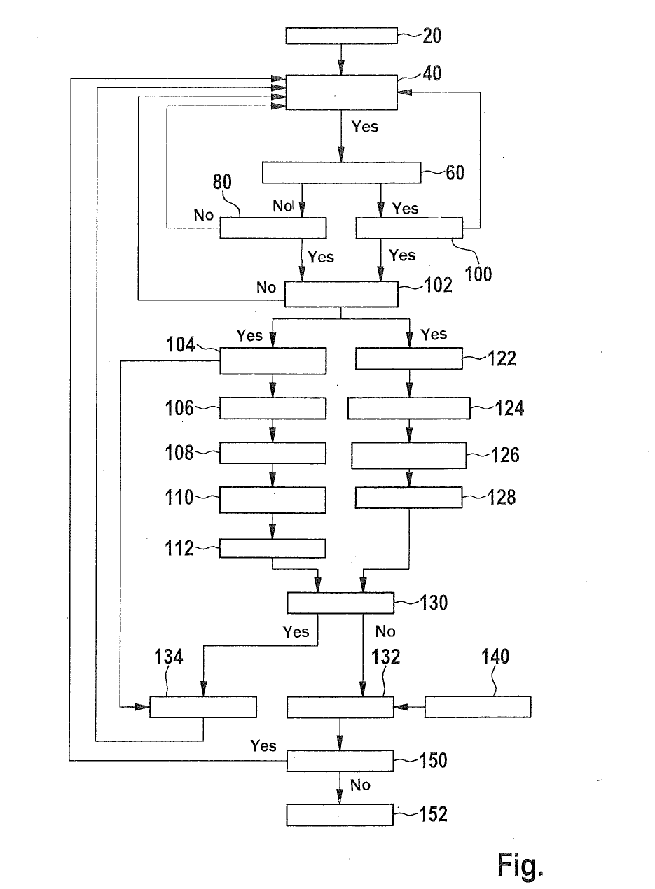

### RELATED APPLICATION INFORMATION

The present application claims priority to and the benefit of German patent application no. 10 2013 217 346.6, which was filed in Germany on Aug. 30, 2013, and German patent application no. 10 2013 217 897.2, which was filed in Germany on Sep. 6, 2013, the disclosures of which are incorporated herein by reference.

### FIELD OF THE INVENTION

The present invention relates to a method for regenerating an electrical energy store in a motor vehicle. Moreover, the present invention relates to a computer program which executes all steps of the method according to the present invention when it runs on a computer, and a data carrier which stores this computer program. Lastly, the present invention relates to a control unit which is configured for carrying out the method according to the present invention.

### BACKGROUND INFORMATION

For saving fuel, present vehicles very often include recuperation devices which allow a recuperation of the kinetic energy in order to charge an electrical energy store, such as a lead-acid battery, in the vehicle. The recuperation may take place during braking and/or coasting phases of the engine. The desired energy savings are greater the more electrical energy that can be stored in the lead-acid battery installed in the vehicle within these recuperation phases. In addition, energy-saving devices are very often provided in present vehicles, for example, so-called start-stop systems which switch off the engine of the vehicle, at traffic light stops, for example, or during other stopping operations in order to save fuel. These systems are referred to below as energy-saving devices. According to the present invention, an energy-saving operation refers, for example, to a switching off of the internal combustion engine during stopping operations, for example at traffic light stops, which is initiated by such energy-saving devices, i.e., start-stop systems.

When a generator that is typically powerful enough is present, the receiving capacity, also referred to below as charge acceptance, of the lead-acid battery, also referred to below as “lead battery” or “battery” for short, is the important limiting factor for the energy quantity that is stored within the recuperation phases, which are usually brief. To improve the charge acceptance of the battery, the battery is therefore held at a low state of charge (SOC) of typically 70%-80% outside the recuperation phases. This partial load range is also referred to as partial state of charge (pSOC). The long-term operation of the lead battery in the pSOC range results in the formation of sparingly soluble lead sulfate crystals, having a large volume and a small surface, at the electrode plates. This phenomenon is referred to as sulfation. Due to the reduction in the active surface of the electrode plates, the utilizable capacity of the lead battery drops, and as a result the charge acceptance also drops significantly. However, with the drop in the charge acceptance, the ability to utilize recuperation potentials also decreases, and there is also an increased risk of generation of negative charge balances during short driving cycles with high consumer load, which over a long period of time may result in untimely stoppage due to the lack of starting capability.

These negative effects of the pSOC operation and the accompanying sulfation may be countered by regular refresh cycles. A method is known in which, in such a refresh cycle with increased vehicle electrical system voltage, the lead battery is charged to an SOC close to 100% or even slightly beyond (overcharging), and this state of charge is maintained for a defined time period. During this time period at a high state of charge, large, sparingly soluble lead sulfate crystals may also dissolve, so that their molecules and the electrode which is blocked by same are once again available for charging/discharging operations. The utilizable capacity as well as the charge acceptance is once again increased due to the reduction in sulfation thus achieved.

A method is discussed in DE 10 2011 006 433 A1 in which, although full charging of the battery (SOC close to 100%) is not necessary, the charging voltage is likewise increased for a defined time period. Also during this time period, due to the charging there is a departure from the state of charge of the battery which is optimal for operation.

An optimization problem now arises in both methods for refresh cycles. Since the charge acceptance of the lead battery decreases the more closely the full state of charge of 100% SOC is approached, and on the other hand the voltage must not be arbitrarily increased in the vehicle electrical system for reasons of component protection, this has the result that at a high SOC only a small charging current results, and therefore it may take considerable time to fully charge the lead battery. This time period also increases when the charge acceptance is reduced due to sulfation. Due to the duration of the full charging operation and the additional necessary resting time for a high state of charge, there is a risk that the vehicle may be parked before the full charging and resting time are reached. If in the subsequent parked period the state of charge once again drops greatly due to overrun and quiescent current until the next trip, this may result in a very long period of time until the refresh operation is completed. For the entire duration of the refresh operation, the option for recuperation is greatly limited or perhaps not even possible at all due to the high SOC and the low charge acceptance.

In addition, the refresh duration would be further prolonged due to discharging during start-stop and/or coasting phases in which the drive is decoupled, for which reason these operating modes frequently must likewise be suppressed. Furthermore, at low temperatures the charging operation, as part of the refresh of the lead battery, takes longer, since at cold temperatures the lead battery has a reduced charge acceptance due to the fact that the battery accepts less current at the same charging voltage. The more advanced the sulfation, the longer the duration of a refresh cycle. It is also possible that sulfation which is too far advanced can no longer be completely eliminated. If the refresh continues over multiple trips due to its lengthy duration, an additional delay results from the time that is required after each phase to once again compensate for the charge loss which has occurred in the meantime during the standing phases. Advanced sulfation results in reduced charge acceptance, and therefore, lower utilization of the recuperation. This also results in an optimization problem in the unutilized or unutilizable energy savings in recuperation phases due to the sulfation and the inability to utilize energy savings in recuperation phases, and/or coasting and/or engine start-stop phases during refresh operations.

There are believed to be various methods (US 2008/0027639 A1, U.S. Pat. No. 8,229,666 B2, U.S. Pat. No. 7,418,342 B1) via which the travel destination likely to be selected by the driver of a vehicle and the corresponding travel route may be determined based on previous trips, including a probability of correctness.

In the present invention, an energy loss which occurs during the regeneration of the energy store is referred to as a first energy loss. Unless a delimitation to the contrary is expressly defined in the present invention, this first energy loss is intended to contain one or more of the following energy quantities:
energy quantities which are to be applied directly for carrying out a refresh operation and which are not recoverable. (Energy portions which are stored during the refresh operation and which subsequently may be completely withdrawn without impairing efficiencies are not included.)
losses of utilizable energy which result from the fact that lower efficiencies are applicable for the generation/conversion of energy during the refresh operation.
additional losses of utilizable energy which result from the fact that energy-saving functions (start-stop, recuperation, for example) cannot be carried out, or cannot be completely carried out, during the refresh operation.
additional losses of utilizable energy which result from the fact that irreversible aging effects occur during the refresh operation.
all additional losses of utilizable energy or not achieved energy-saving possibilities, which are justified by the ongoing refresh operation.

In addition, in the present invention an energy loss due to reversible aging effects is referred to as a second energy loss. Unless a delimitation to the contrary is expressly defined in the present invention in reference to the second energy loss, this energy loss is intended to contain one or more of the following energy quantities:
losses of utilizable energy which result from the fact that recuperation phases cannot be energetically utilized, or cannot be completely energetically utilized, due to reversible loss of capacity and/or an increase in internal resistance of the energy store.
losses of utilizable energy which result from the fact that energy-saving functions (start-stop, for example) cannot achieve, or cannot completely achieve, their energy savings potential due to reversible loss of capacity and/or an increase in internal resistance of the energy store.
losses of utilizable energy which result from the fact that efficiencies are impaired due to reversible aging effects of the energy store.
all losses of utilizable energy which are justified by reversible aging effects of the energy store.

Energy losses due to irreversible aging effects are not to be taken into account in this energy loss.

### SUMMARY OF THE INVENTION

The method according to the present invention for electrically regenerating an electrical energy store allows the optimization of the electrical regeneration of the energy store, in particular a lead battery, taking into account utilizable recuperation operations and/or taking into account utilizable energy-saving operations and/or taking into account energy-saving operations to be avoided, such as switching off the internal combustion engine by a start-stop device during a stop. The method allows anticipatory planning and carrying out of refresh cycles with what may be little limitation of energy-optimized operating strategies of the vehicle. For this purpose, based on information concerning an upcoming travel route, it is ascertained whether a suitable opportunity exists for an electrical regeneration on the upcoming travel route. A first energy loss which occurs during the electrical regeneration is determined. At the same time, a second energy loss is determined which results on a plurality of previously determined and defined routes due to aging effects of the energy store which are reversible with the aid of refresh.

These reversible aging effects may be, for example, a decrease in the storage capacity and/or an increase in the electrical charge internal resistance. The charge internal resistance is also referred to below as “charge acceptance,” this term being used in particular for lead-acid batteries. The first energy loss and the second energy loss are compared, and a regeneration is carried out only when the second energy loss is greater than the first energy loss. In other words, an energy weighting or an energy balancing is made between a first energy loss, which results when a suitable opportunity for an electrical regeneration is possible on an upcoming travel route, and an energy loss of the recuperation energy, which is not storable due to the reduced charge acceptance of the lead battery on a plurality of previously determined and defined routes. The reduced charge acceptance occurs when there is an increased sulfation rate of the lead battery. When a comparison of the second energy loss and the first energy loss shows that the second energy loss is greater than the first energy loss, a regeneration of the lead battery, i.e., a refresh, is carried out, but not in the reverse case.

Strictly in principle, a route on which only a partial regeneration is possible is already considered to be a suitable opportunity. A suitable opportunity for an electrical regeneration advantageously refers to a route on which a complete electrical regeneration of the electrical energy store is possible. A route on which there may be no interruption of the trip may particularly be the case. However, routes having interruptions are also possible. In this case, although the regeneration process of the electrical energy store is interrupted, it is resumed and carried out further in the continuation of the trip.

According to one advantageous embodiment of the method, information concerning an upcoming travel route includes predictive data, in particular data of a planned route, and/or adaptive data, in particular the recognition of previously traveled routes, and/or speculative data, in particular likely traveled routes based on roadway types, driver behavior, and the like. This electronic information may be provided, for example, by the so-called electronic horizon, floating car data, extended floating car data, or dynamic road maps, as well as navigation systems having predictive map data and even Internet data.

The term “electronic horizon” is presently understood in particular to mean roadway gradient and curve shape, and legal speed limits, as well as additional attributes such as intersections, traffic lights, number of lanes, tunnels, etc. These parameters are ascertained as stationary attributes along the upcoming route as a function of the instantaneous vehicle position. The electronic horizon is provided by the so-called horizon provider (HP), which, for example, may be an integral component of navigation systems. The future selection of routes by the driver may be ascertained based on the driver's inputs for the route guidance of the navigation system. Without route guidance, a “most probable path” (MPP) is usually likewise transmitted, which is ascertained based on the underlying roadway classes or based on statistics concerning previously traveled routes. Optionally, the HP ascertains alternative routes which the driver might also select. In the present patent application, the term “MPP” is used as a representation of the most probable route and possible alternative routes.

Floating car data (FCD) refer to data which are generated, in a manner of speaking, from a vehicle which at that moment is involved in traffic events. This includes the state of driving as well as the state of standing, for example in a traffic jam, in front of traffic lights, or at a waiting area. A data record contains at least the time stamp and the instantaneous coordinates. By use of the FCD method, the vehicles thus become mobile sensors. At the present time, primarily taxi fleets are used for generating FCD, since they already have the necessary equipment together with a control center for the tasks of fleet management.

Extended floating car data (XFCD) are an enhancement of FCD. In this case, data from driver assistance systems such as ABS, ASR, ESP, rain sensors, etc., are used to recognize traffic-relevant driving situations via sensor data fusion, and to prepare same as FCD. Thus, based on the ABS and ESP, for example, an icy roadway segment may be recognized. In this case, the terminal in use sends this information in a situation-controlled manner to the FCD control center, which checks plausibility of the data by comparing various FCD participants, and after completion of plausibility checking, sends a message for the relevant roadway segment in order to warn subsequent drivers.

The further development of dynamic road maps includes traffic sign recognition, such as traffic signs which regulate vehicle speeds, with the aid of cameras installed in the vehicle and transmission of the data to the application provider. In particular speed limits (traffic signs showing the speed limits), speed limit cancellations (discontinuation of speed limits), travel into urban areas (i.e., speed limits up to 50 km/h), travel out of urban areas (i.e., discontinuation of speed limits), and curve shapes are detected and utilized. The road map is electronically stored on a memory medium, for example on a server or cloud computing. The drivers of motor vehicles are at least temporarily connected to the dynamic map on the server or cloud computing on their mobile terminal via an application such as navigation. An industry standard is available for the transmission of data from a navigation system to other components in the vehicle. This so-called ADASIS standard is in continuous further development. Initial implementations of this ADASIS interface are realized, for example, in so-called “integrated predictive cruise control” (IPCC), and are known from US 2004/0068359 A1.

Lastly, there are also navigation systems which include predictive map data, in particular gradient information, speed information, elevation information, and the like. Information which represents the user behavior of drivers may also be collected via the Internet.

According to one embodiment of the method according to the present invention, previously determined and defined routes may be taken from a memory which contains the navigation data and/or vehicle data and/or external data, in particular concerning the traffic volume, stopping operations which have occurred, speeds driven, and accelerations which have occurred during previous driving operations. In this regard it is assumed that when such a route is traveled again, there is a certain probability that similar situations will recur, so that the previously determined and defined routes allow a rather good decision-making criterion as to whether or not recuperation operations or other energy-saving operations are possible and energetically utilizable on these routes.

The method is started only when the capacity of the lead-acid battery is below a predefinable threshold value.

The method is also started as a function of the detected ambient temperature and/or the temperature at the energy store.

It may also be provided to start the method as a function of predicted changes in the ambient temperature and/or predicted weather conditions and/or the predicted temperature at the energy store.

The above-described necessary assumptions for energy balancing may be automatically modified during operation when deviations from assumptions are identified.

The method may be very advantageously realized as a computer program which is implemented in a control unit of the vehicle. No structural changes are necessary for this purpose. The data carrier according to the present invention stores the computer program according to the present invention. By running the computer program on a control unit, the control unit according to the present invention is obtained, which is configured to have the method according to the present invention executed.

Exemplary embodiments of the present invention are illustrated in the drawing and explained in greater detail in the following description.

### BRIEF DESCRIPTION OF THE DRAWING

The FIGURE schematically illustrates a flow chart of the method according to the present invention.

### DETAILED DESCRIPTION

After checking of various preconditions in steps 20 through 100 is completed, initially it is recognized in a step 102 whether there is a need for a battery refresh, i.e., whether the capacity of the battery is below a first threshold value. This first threshold value is applicable. The first threshold value for activating the refresh may also be made a function of the state of health (SOH) in order to take the aging of the battery into account. With increasing aging, the capacity of the battery itself continues to decrease after a refresh, as the result of which the capacity threshold for recognizing a sulfated battery is influenced.

After the need for a battery refresh has been recognized, the necessary refresh time is determined as a function of the battery type, the battery capacity, and the SOH. These data are determined offline by testing, and are stored in the control unit with the aid of application data. The planning of a battery refresh then takes place, using prediction. With the aid of the predictive data, such as a planned route, and/or adaptive data such as the recognition of previously traveled routes, and/or speculative data such as likely traveled routes based on roadway types, driver behavior, etc., a conclusion may be drawn concerning the possibility of a complete, i.e., interruption-free, refresh operation during one of the subsequent future travel routes.

Probability P concerning whether a refresh is possible on a predicted route, possibly with interruption by parking, is ascertained in step 104.

When this probability P exceeds a predefinable minimum probability, the route length necessary for a complete refresh is ascertained in step 106.

The energy which is recuperable along the refresh route is estimated in step 108, and the energy loss which occurs during the refresh is ascertained in step 110. This energy loss also includes all energy savings which are not achievable due to energy-saving functions which must be suppressed or degraded during the refresh. This entire energy loss is determined as energy loss 1 in step 112.

In contrast, if probability P for the refresh possibility is lower than the predefined minimum probability, no refresh is carried out, and a skip is made to step 134. Simultaneously with steps 104 through 112, for the case that the capacity is less than the first threshold value (step 102), the charge acceptance of the lead battery as a function of the sulfation to rate is ascertained (step 122).

In steps 124 and 126, an estimation is now made of the driver-dependent recuperation energy as well as the possibility for utilizing other energy-saving measures which are a function of the battery state (for example, start-stop, coasting, etc.) on typical future routes which have been previously ascertained and stored in a memory. Statistical data may also be used for this purpose.

The energy losses caused by reversible aging effects (for example, due to reduced charge acceptance and/or battery capacity, nonstorable recuperation energy, or other energy-saving operations which cannot be carried out) on these typical routes are ascertained (step 126), and an energy loss 2 is determined therefrom (step 128). This energy loss 2 is compared to energy loss 1 in step 130, and if energy loss 1 is not greater than energy loss 2, i.e., conversely, if energy loss 2 is greater than energy loss 1, a refresh of the battery is carried out (step 132). In other words, a battery refresh is planned using prediction. With the aid of the predictive data, for example of a planned route, and/or adaptive data, for example of the recognition of previously traveled routes, and/or speculative data, for example of likely traveled routes based on roadway types, driver behavior, etc., a conclusion may be drawn concerning the possibility of a complete, i.e., interruption-free, refresh operation over one of the subsequent future travel routes.

The meanings of predictive data, adaptive data, and speculative data according to the present invention are explained in greater detail below. If a conclusion may be drawn concerning a subsequent trip in real time or a trip in the opposite direction, such as a return trip, based on the destination and user behavior, for example via a calendar to entry (Google Now) and/or previously traveled routes, the refresh operation may also take place on the outbound trip and the continuing trip or return trip. The duration of the interruption of the refresh operation between the trips must be taken into account. The influence of the duration of the interruption of the charging operation and of the duration of the interruption of the resting time may be ascertained offline. If the battery capacity drops below a second predefined applied threshold value which is less than the first threshold value, the refresh of the battery is begun immediately to avoid the risk of complete loss of usability of the battery, such as the loss of starting capability (step 140). A gradation having multiple threshold values and correspondingly combined stepwise switching off of electrical consumers, or the prevention of functions which result in discharging or noncharging of the battery (for example, start-stop operation, so-called coasting operation), is also conceivable.

When a sufficiently long trip duration is predicted for a refresh using the prediction, it may possibly be meaningful to carry out the refresh during this trip, even if the refresh would have been provided only later according to the customary sequence. One advantage of carrying out the refresh during this long trip would be that the refresh is not further prolonged by numerous interruptions/parking phases.

If the last refresh is only very recent, a check must be made as to whether a new refresh is advantageous at all in terms of overall energy. It may possibly be more meaningful to use the charge acceptance of the battery that is still present in order to save the largest possible amount of energy by recuperation, start-stop operation, coasting operation, etc., on the long route. It is also taken into account that the charge acceptance of the battery is also reduced after the refresh until the optimal target pSOC for a recuperation is once again achieved. The decision may be made based on the rate of sulfation or the time that has elapsed since the last refresh and the expected energy savings of the predicted route, which are applicatively stored as threshold values in the control unit.

Optionally, for deciding to carry out a refresh, it is possible to use the loss of recuperation potential, start-stop potential, and coasting potential during the refresh, together with the improved charge balance and thus reutilizable (additional) estimated recuperation potential or savings from stops and/or coasting phases, which are then longer. The consumers are supplied from the battery during the coasting phases, which reduces the SOC, as a result the duration of the refresh once again being increased. The optimal ratio of normal operating cycles to refresh cycles must be found. This optimum may depend greatly on the typical use profile of the driver, and, based on the previous use behavior of the driver, may be adapted (learned) online (estimation: loss of future recuperation potential, start-stop potential, and coasting potential during the refresh and the future improved charge balance, and thus, the reutilizable additional estimated recuperation potential or saving by once again longer energy-saving operations, i.e., longer stops and/or coasting phases). In addition, the decision to carry out the refresh may be delayed or canceled if the positive effects of the refresh are eliminated due to other aging phenomena, sulfation excepted. Such aging phenomena are facilitated by the increased charging voltage during the refresh operation, and may likewise impair the battery capacity and/or the charge acceptance. The decision to delay the refresh may be made based on an aging or damage factor of the battery. The decision concerning whether a refresh is still effective may still be made based on the comparison of the measured battery capacity before and after a refresh. The comparison is made based on an applicable threshold of the change in capacity. The applicable threshold may optionally be made a function of the duration of the refresh (a shorter refresh duration allows fewer improvements in capacity).

Since the battery must be charged and temporarily kept in this state during the refresh, any function which appreciably discharges the battery, such as start-stop operations, boosting in the case of hybrid vehicles, and the like, must be suppressed. However, all electrical consumers which “draw” power/current when the engine is running tend not to be a problem, since in this case the generator is running and ensures an even power balance. The only problem here involves the rare cases in which the battery charge and the consumers in total require more current than the generator can deliver at that moment. Therefore, a generator capacity utilization of <100% (step 40) is one of the basic conditions that must be met before a refresh may be carried out. In addition, at cold temperatures the charging operation, as part of the refresh of the battery, takes longer, since the battery has a reduced charge acceptance at cold temperatures; i.e., the battery accepts less current at the same charging voltage. For this reason, according to the present invention, carrying out a refresh would be prohibited as long as the power balance of the generator is not compensated for due to additional consumers (step 40), and/or the battery temperature has dropped below an applied temperature value, or, in other words, the battery temperature and ambient temperature are in a range that is favorable for a refresh (step 60). For planning the need for a refresh at a future time, weather data (in particular the temperature) are therefore also included in the optimization (step 80.) For example, a refresh may be advanced, or allowed despite unfavorable temperatures, if further deterioration of the temperature conditions is predicted for the near future. In this case, a skip is made to step 102. Due to the high thermal mass of the battery, only a rough prediction of the temperature is necessary.

In addition, a delay of the refresh is possible when the battery temperature is above an applied temperature threshold due to internal and/or external heating, such as from the internal combustion engine, for example due to radiant heat. The delay time may be included in the prediction (step 100). A skip is made only to step 102 if a predefined minimum time has elapsed since the last refresh.

After a refresh is completed, a check is made as to whether carrying out the refresh meets the assumptions made during the energy balancing for improving the battery parameters (step 150). If this check shows a deviation from the previous assumptions, the assumed values stored for the energy balancing are appropriately modified to increase the quality of future energy balancings (step 152).

For optimizing the refresh strategy, it is also necessary to record information in the so-called electronic horizon (EH) which sometimes is not contained in the electronic horizon known from the related art. The information to be recorded is as follows:
a profile which indicates the recuperation potential along the route. This profile is created by the HP based on topological and geographical properties of the route. Thus, for example, a route segment having a downhill grade offers the possibility for recuperation, the same as a route segment on which the speed of the vehicle must be reduced, for example due to speed limits. In addition, routes having numerous intersections or curves have a high recuperation potential, since it may be necessary to brake prior to each intersection or curve. Present digital navigation maps contain gradient data, curve information, speed limits, and the position of intersections. In the digital map, information in each case is based on the route; for example, the approximate position of a sign showing a speed limit is known. Accordingly, a computation may be made that for a certain length there is an increased recuperation potential over the distance immediately prior to this sign. However, a time reference is necessary for the refresh strategy. This time reference may be provided based on the speed profile, which likewise is derived from the digital map. Thus, with knowledge of the instantaneous position of the vehicle, the information may be deduced, for example, that in one minute there will be an increased recuperation potential for five seconds. The prediction of the recuperation potential may be improved when it is taken into account when recuperation was carried out in the past when traveling the same route. For this purpose, during each trip a record is made of when, where, and how much energy has been recuperated. Based on these data, it may be ascertained how much energy is recuperated on average on certain route segments as a function of the driver. Since a recuperation phase may also be brought about by unforeseeable traffic situations, outliers are filtered out prior to computing the average values. A plot of recuperation power as a function of time is a suitable representation of the recuperation phases. To simplify the transmission of the recuperation phases in the EH, ranges with similar recuperation power are combined. For example, a range in which recuperation is carried out continuously between 5 kW and 10 kW over a period of ten seconds may be combined. For this purpose, the average recuperation power over this time period is computed (7 kW, for example) and transmitted in the EH together with the duration and the phase (in this case, ten seconds) and optionally the variance of the power.
a profile containing the driving states which become active along the MPP. Examples of such driving states are coasting and start-stop phases. The driving states may be predicted with knowledge of the operating strategy of the vehicle and the expected elevation and speed curves. The prediction may be improved by using the driving states which have been selected along the traveled route in the past. For this purpose, the appropriate data are collected in a statistics module. Alternatively, instead of the driving states themselves, the parameters which have been used for selecting the driving state, such as elevation and speed profiles (including standing times), may be stored. These data may also be collected on a server and distributed wirelessly to the vehicles in aggregated form, since these data, in contrast to the selected driving states, are independent of the vehicle. The speed profile (the same as other profiles) is typically indicated via distance in the EH. A time reference is necessary for predicting start-stop situations. For this reason, in addition to the distance-related speed profile, a distance-related standing time profile which contains the position and the expected duration of the standing phases is transmitted in the EH.
information concerning the expected remaining travel time, including the probability (optional) that the prediction is correct. This information may be obtained from the navigation system of the vehicle, provided that the user is using the navigation system for route guidance. If the user is not using the navigation system, the remaining travel time, as mentioned in the related art, is computed, based on statistics about the routes which the driver has traveled in the past.
In the simplest form of such statistics, the time and starting point of the destination to which the driver has traveled is recorded. This information is recorded even if the driver is not actively using the navigation system. The positions of the origin and destination locations of a trip may be stored in the form of GPS positions or some other georeference. The reaching of a travel destination may be recognized, for example, in that the driver switches off the engine, and the vehicle is not moved for some time before the next start. The points in time of the start of the trip and the end of the trip, including the date, are stored to the split second. Based on the recorded data, regular trips having a fixed origin and destination, such as a trip to work, may be recognized. By use of the statistics, with knowledge of the instantaneous time of day and the instantaneous GPS position, the destination of a trip which has been traveled at least once in the past may be predicted. The remaining travel time may be predicted based on the average trip duration of the trips recorded in the statistics. The more frequently the presumably same route has been traveled in the past with similar time-date combinations, the higher the probability that the prediction of the remaining travel time is correct. The more routes there are with an identical starting point, but with travel to another destination with similar time-date combinations, the lower the probability that the prediction of the remaining travel time is correct. The probability transmitted in the EH is appropriately selected. In an enhanced form of these statistics, not only the origin and destination of the traveled routes, but also points between the origin and destination are recorded. A georeference (GPS position, for example) as well as the time at which the vehicle has passed the point are stored for each of these intermediate points. Suitable positions for such intermediate points are intersections, since at these locations there is a possibility for branching from the route. With this type of statistics the remaining travel time may be better predicted, since when an intermediate point is reached, the average remaining travel time from previous trips (the same route with the same destination), starting from this intermediate point to the destination, may be given as the new remaining travel time. For this reason, when an intermediate point is reached, an update of the predicted remaining travel time is typically sent via the EH to the control unit in which the refresh strategy is implemented. This control unit is representatively referred to as the “vehicle electrical system control unit” below. In addition, the enhanced statistics may be used to distinguish between recorded routes that overlap. For example, two routes which have the same starting point but different destinations may match one another. Based on the instantaneous position of the vehicle and the position of this intermediate point, it is recognized that the destination associated with the intermediate point is likely being traveled to, and the prediction of the remaining travel time is appropriately modified. From this point in time, i.e., as long as the two routes still match one another and it is not known which of the two possible destinations the driver is heading for, either both remaining travel times, including the corresponding probabilities, or the predicted minimum or maximum remaining travel time which directly results from the two possible destinations, is/are given. The same procedure is followed for more than two possible routes. In addition, based on the intermediate points it may be recognized when the driver deviates from a route that is recorded in the statistics. If the position of the vehicle after the deviation does not indicate any routes which are recorded in the statistics, the vehicle electrical system control unit is signaled via the EH that an estimation of the remaining travel time is not possible. Based on the statistics, the location and the duration of recurring interruptions of the trip may also be ascertained. The statistics may also be used for estimating the remaining travel time when the driver is using the navigation system for route guidance, since the destination input by the driver is possibly incorrect, or the driver continues to travel after reaching the destination which has been input in the navigation system.

An operating strategy for carrying out the refresh is described below. Over the entire duration of the refresh operation, according to the present invention the possibility for recuperation is greatly limited or not permitted at all due to the high SOC and the low charge acceptance. In addition, the refresh duration would be further prolonged due to discharging during start-stop and coasting phases, for which reason the start-stop operation, including the (engine) coasting operation, is not permitted. If the refresh is planned for the route, and the duration of the process necessary for the refresh is less than the expected trip duration, the refresh phase must be carried out within the segment of the travel route in which the least possible recuperation potential remains unused, or alternatively, in which the refresh may be carried out to the greatest possible extent using recuperation energy (utilization of recuperation energy for the refresh).

A complete refresh may take a long time, depending on the battery. To estimate whether a complete refresh is possible on the predicted travel route, a forecast of appropriate length is necessary. The maximum length of an electronic horizon transmitted via ADASIS is presently a good eight kilometers. If the length of the EH is not sufficient for the estimation, the estimation may be transferred into the HP (into the navigation system, for example). This has the advantage that a sufficiently long horizon is created in the working memory of the HP, and may be directly used for the estimation without having to transmit this long horizon via the CAN bus. The result of the estimation is sent via the CAN bus to the vehicle electrical system control unit in the form of a few signals. In particular for the estimation of where on the travel route the refresh is to take place, a transfer into the horizon provider (HP) is meaningful, since an even longer forecast may be needed for this purpose. The driver may be informed via a signal device, such as a display light on the instrument panel, at the exact moment when a refresh is taking place. The driver thus has the option to appropriately modify the travel route.

The above-described method, which takes into account predictive data, in particular a planned route, and/or adaptive data, in particular the recognition of previously traveled routes, and/or speculative data, in particular likely traveled routes based on roadway types and driver behavior, may be implemented very advantageously as a computer program in one or multiple control units of the vehicle. The method may thus also be retrofitted in existing vehicles, since it is not necessary to install additional hardware. The program itself may be stored on a data carrier.

What is claimed is:

1. A method for electrically regenerating an electrical energy store in a motor vehicle which includes at least one of a recuperation device and at least one other energy-saving device, the method comprising:
ascertaining, based on information concerning an upcoming travel route, whether a suitable opportunity exists for an electrical regeneration on the upcoming travel route; and
when this is the case, performing the following:
determining a first energy loss which occurs during the electrical regeneration;
determining a second energy loss which results on a plurality of previously determined and defined routes due to aging effects of the energy store which are reversible with the aid of regeneration;
comparing the first energy loss and the second energy loss; and
performing a regeneration only when the second energy loss is greater than the first energy loss.

2. The method of claim 1, wherein the information concerning an upcoming travel route includes the following:
predictive data, adaptive data, and/or speculative data.

3. The method of claim 1, wherein the previously determined and defined routes are taken from a memory which contains the navigation data and/or vehicle data and/or external data.

4. The method of claim 1, wherein the energy store is a lead-acid battery.

5. The method of claim 4, wherein the method is started only when the capacity of the lead-acid battery is below a predefinable threshold value.

6. The method of claim 1, wherein the method is started as a function of at least one of the ambient temperature and the temperature at the energy store.

7. The method of claim 1, wherein the method is started as a function of at least one of predicted changes in the ambient temperature, predicted weather conditions, and the predicted temperature at the energy store.

8. The method of claim 1, wherein the assumptions necessary for comparing the first energy loss to the second energy loss are automatically modified during operation when deviations from assumptions are identified.

9. A computer readable medium having a computer program, which is executable by a processor, comprising:
a program code arrangement having program code for electrically regenerating an electrical energy store in a motor vehicle which includes at least one of a recuperation device and at least one other energy-saving device, by performing the following:
ascertaining, based on information concerning an upcoming travel route, whether a suitable opportunity exists for an electrical regeneration on the upcoming travel route; and
when this is the case, performing the following:
determining a first energy loss which occurs during the electrical regeneration;
determining a second energy loss which results on a plurality of previously determined and defined routes due to aging effects of the energy store which are reversible with the aid of regeneration;
comparing the first energy loss and the second energy loss; and
performing a regeneration only when the second energy loss is greater than the first energy loss.

10. A data carrier having a computer program, which is executable by a processor, comprising:
a program code arrangement having program code for electrically regenerating an electrical energy store in a motor vehicle which includes at least one of a recuperation device and at least one other energy-saving device, by performing the following:
ascertaining, based on information concerning an upcoming travel route, whether a suitable opportunity exists for an electrical regeneration on the upcoming travel route; and
when this is the case, performing the following:
determining a first energy loss which occurs during the electrical regeneration;
determining a second energy loss which results on a plurality of previously determined and defined routes due to aging effects of the energy store which are reversible with the aid of regeneration;
comparing the first energy loss and the second energy loss; and
performing a regeneration only when the second energy loss is greater than the first energy loss.

11. A control unit to control an electrical regeneration of an electrical energy store, comprising:
a regenerating arrangement for electrically regenerating an electrical energy store in a motor vehicle which includes at least one of a recuperation device and at least one other energy-saving device, which performs the following:
ascertaining, based on information concerning an upcoming travel route, whether a suitable opportunity exists for an electrical regeneration on the upcoming travel route; and
when this is the case, performing the following:
determining a first energy loss which occurs during the electrical regeneration;
determining a second energy loss which results on a plurality of previously determined and defined routes due to aging effects of the energy store which are reversible with the aid of regeneration;
comparing the first energy loss and the second energy loss; and
performing a regeneration only when the second energy loss is greater than the first energy loss.

12. The method of claim 1, wherein the information concerning an upcoming travel route includes the following:
predictive data, in particular of a planned route, and/or adaptive data, in particular the recognition of previously traveled routes, and/or speculative data, in particular likely traveled routes based on roadway types and driver behavior.

13. The method of claim 1, wherein the previously determined and defined routes are taken from a memory which contains the navigation data and/or vehicle data and/or external data, in particular concerning the traffic volume, stopping operations which have occurred, speeds driven, and accelerations which have occurred during previous driving operations.
